(19) United States
(12) Patent Application Publication
(10) Pub. No.: US 2016/0149359 A1
(43) Pub. Date: May 26, 2016

(54) Free-standing power strip accessory

(71) Applicant: Tony Daniel Bost, Sumner, TX (US)

(72) Inventor: Tony Daniel Bost, Sumner, TX (US)

(21) Appl. No.: 14/544,105

(22) Filed: Nov. 25, 2014

(51) Int. Cl. H01R 24/20; F16M 11/40; F16M 11/04; F16M 11/28

(52) U.S. Cl. CPC H01R 24/20; F16M 11/28; F16M 11/40; F16M 11/04

(57) ABSTRACT

A free-standing apparatus comprising of: three legs of equal length for maintaining balance of the structure; two vertical poles in which one pole (telescopes) slides in and out of the other pole being set at any height within the devices' limits; a silicone or rubber-like coupler which allows the device to remain at a preferred height; an accordion tube (plicate styled) which contorts various directions during use of the device; a securable housing component for which a power outlet strip can be retained; and two elastic bands which provide a secure front to the securable housing component. There is an opening which the power strips' electrical cord can pass through located in the upper portion of the pole which slides in and out of the base pole of the apparatus. The accordion (plicate) component remains bent and unseen until ready for use which it's then contorted upwards for use.

### SUMMARY

The present invention pertains to a device which accommodates power outlet strips comprising of: Three legs for the function of proper balance in which there will be a 90 degree angle between each of the three legs aside from the back of the invention in which there will be a degree of 180 with the legs ultimately having the appearance of a capital “T” whereas each stem of the “T” will be of equal length according to the actual invention; a pole (bracing), which is a fixed base (stable) pole and a mobile (moving) pole which will slide into the base pole to ultimately shorten the vertical height of the entire device to the preference within the limits; the mobile pole which can also slide back up and be stabilized at the desired height within the extent the device can be raised. A silicone rubber-like coupler piece which is mounted on the top of the base pole will provide the mobile pole of the device to remain at a set position; an accordion/plicate material in a tube-like form which can contort to multiple angles; a securable housing component will be attached to the top of the accordion/plicate component which will bend in whatever direction the accordion/plicate component is flexed or turned; two securing bands on the securable housing component that provide frontal support of the electrical device that is placed in the securable housing which are made of a rubber-like or silicone material. The legs will simply screw into the bottom of the base pole. Furthermore, this information entails the summary of a unique, free-standing power strip accessory.

### BACKGROUND OF THE INVENTION

1. Field of Invention

The present invention relates to a structure which is applied to power outlet strips in that the invention will allow power strips to be in ease of reach for users as the device holds the power outlet device at a set height preferred by the user. The invention will greatly reduce the annoyance of stooping over and searching for the power outlet strip as would normally occur without the use of the present invention.

2. Description of Related Art

Power outlet strips are often placed behind sofas and other hard to reach areas in which a person must either undesirably move the sofa or reach behind it to retrieve the power strip for use. The cords plugged into power outlet strips tend to have a great amount stress placed upon the cords due to the angle at which they are positioned. This is mostly due to the power outlet strip-as most function in the standard of a rectangular strip which lays flat on the floor. Although, there are various types of power outlet strips available the most common is the standard one as previously described and used by most people. The power outlet strips would be greatly complimented by a device that allows the power outlet strip to be far easier to reach even behind sofas and ready for use without the ordinary restriction of fetching it.

The current issue resides with the individual and especially the elderly in which many factors arise when bending over to obtain an object or do something while bent over. Factors can arise such as blood pressure change in bending over and coming back up too quickly in which a device that prevents the user from having to stoop over to such an extent to reach their power strips would indeed be advantageous. When a power outlet strip is found behind a couch or object where there is little light, it is frustrating enough to see the plug in notches of the power outlet strip. However, in the event that an individual has the ability to simply grab the top of a device which holds the power outlet strip and handily would allow them to better see the power strip for use. Power outlet strips currently do not have the option of what the present invention allows which provides a person with a power outlet strip the functioning benefits of a device such as that which is presently disclosed.

### BRIEF SUMMARY OF DRAWINGS

FIG. 1 is a front view of the invention showing the device fully extended and not bent;

FIG. 2 is a fully extended side view showing the device bent;

FIG. 2A accommodates FIG. 2 as a blown up portion of the invention to show clarity;

FIG. 3 is a fully extended side view which is not bent;

FIG. 4 is a fully extended front view showing the device bent;

FIG. 5 is a fully shortened front view showing the device bent;

FIG. 5A accommodates FIG. 5 as a blown up portion of the invention to show clarity;

FIG. 6 is a fully shortened side view showing the device bent;

FIG. 7 is a fully shortened side view which is not bent;

FIG. 8 is an overhead (top) view of the invention;

FIG. 9 is a fully shortened front view which is not bent;

FIG. 10 is an exploded view of the invention showing the device as if it is prepared to be assembled.

### DETAILED DESCRIPTION

The present invention relates to a device that is safe to use around electrical items since the device will be able to hold a power outlet strip at various heights and angles of bend within its preferred limits. The intended purpose of the invention is to provide individuals the ability to not have to search for their power outlet strips and stoop to any strenuous extents to retrieve the power outlet strip. The present invention can be used in various places as needed such as a living room, bedroom, or other rooms of an individuals' home, workshops or work office of business as well. The device as described will be designed to perhaps be placed behind a Sofa which is against a wall for example, in which the legs will be thin enough and angled properly to do so without the need of sliding the couch far at all from the wall, and to also have at least one leg which rests underneath the couch for convenience. Individuals often have the issue of not being able to see the power outlet plug-ins of their power outlet strip because of the power strip being behind an object and difficult to locate. Using the current invention the user does not have this unfortunate circumstance for they will have the power outlet strip contorted upwards to their sight and reach and ready for preferred use given the capabilities of the present invention disclosed.

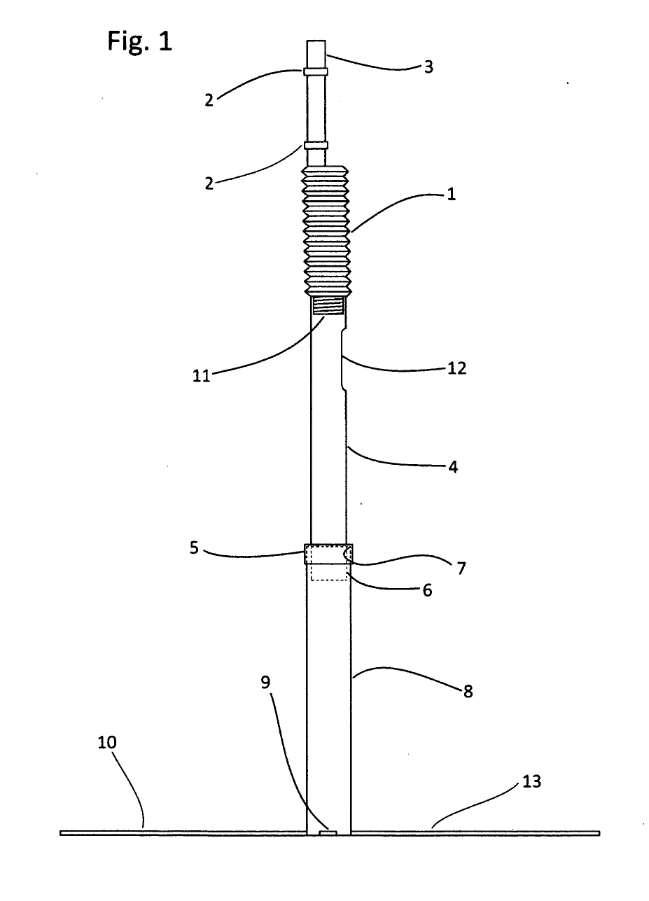

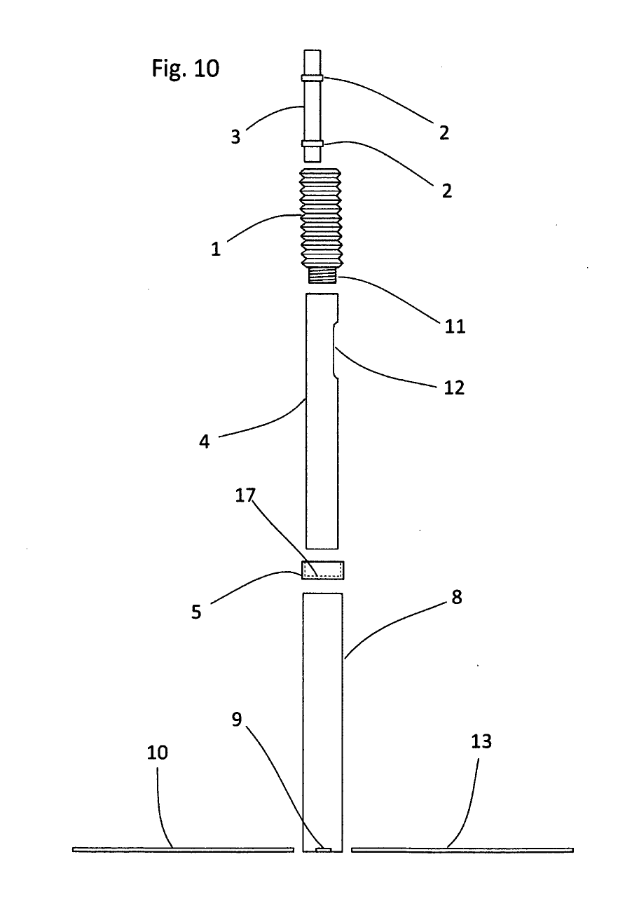

Furthermore, in reference to FIG. 1, a fully extended front view is demonstrated to show the device and its elements. When looking at the device in FIG. 1, the left leg 10 which is a leg bracing for support and balance of the present invention whereas the right leg 13 in comparison to leg 10 is directly on the other side of the device with a 180 degree angle relative to the leg 10. In FIG. 1, there is also leg 9 which is only seen as a frontal view in this image; the leg 9 also accommodates the leg 10 and leg 13 to complete the inventions fundament for structure support and balance. Each leg 10, 9, and 13 are of equal lengths of about 16 inches when they are attached to the base pole 8 as shown in FIG. 1 and later demonstrated in reference to FIG. 10. As the legs 10, 9, and 13 connect with the base pole 8, first shown in FIG. 1; they may lose about an inch in the attachment process. However, dependent upon the method of preferred attachment; the legs 10, 9, and 13 will still each be of equal lengths. Each leg 10, 9, and 13 can be made of a durable plastic material as well as the base pole 8 and the mobile pole 4, as shown in FIG. 1.

In FIG. 1, the mobile pole 4 can slide up and down (telescope), the base pole 8 as described. Currently, the mobile pole 8 of FIG. 1 is showing the pole to be fully extended to its limit of maximum height provided that FIG. 1 entirely is about 50 inches in complete height. The mobile pole 8 is 18 inches in height, however, only 16 inches is actually shown sticking out of the base pole 8 in which the dashed line 6 of FIG. 1 clearly represents the two inches of the mobile pole 4 which is still inserted inside of base pole 8. Furthermore, base pole 8 of FIG. 1 is also 18 inches in height. Reference number 7, in FIG. 1, represents an inch of the remaining, non-darkened, line of the base pole 8 so that it is understood that the darkened line next to the dashed line 7 is actually reference number 5 which represents the silicone (rubber-like), coupler component that will be at the top of the base pole 8. The coupler component 5 will be at the top of the base pole 8 with about 1 inch on the outside and inside of the pole to provide the coupling effect of the mobile pole 4 as it can be slide in and out of the base pole 8 for adjustable heights of the present invention.

Reference number 12, in FIG. 1, represents a front view of the opening in which the electrical cord of the power outlet strip may pass through; this will also be demonstrated more comprehensible in other Figure drawings present. The power strip cord opening 12 is 4 inches in vertical length and an inch and a half wide on the upper portion of the mobile pole 4 which is 2 inches from the top of the mobile 4. Reference number 1 in FIG. 1 resembles the serviceable plicate component which is also an accordion-like tube which bends, folds, collapses, flexes, and contorts in multiple directions and angles for preferred use. The accordion (plicate), tube 1 of FIG. 1 is estimated to be 9 inches in length, however, only 8 inches will be seen protruding out of the top of the mobile pole 4 in which reference number 11 represents the one extra inch of the accordion (plicate) tube that screws into the top of the mobile pole 4.

The screw capable part 11 is one inch in length providing the accordion (plicate) tube is a length of 9 inches. Accordingly, the top inch of the inner portion of the mobile pole 4 will be threaded so that the screw capable part 11 can successfully be attached to the device for continued use. The accordion (plicate), tube 1 (and 11), being that 11 belongs to the accordion (plicate), tube is composed of a durable yet flexible plastic material with the screw capable part 11 composed of a stiff plastic material for proper function. At the top of the device show in FIG. 1, there is the reference number 3 which resembles the securable housing component for a power outlet strip which can be made of a durable plastic material. The securable housing component can be attached to the top of the accordion (plicate), tube 1 by the means of a glue adhesive or a machine coupling process. As the accordion (plicate) tube is contorted to whatever various angle that it points towards, the securable housing component 3 will bend in the same direction as it is attached to the accordion (plicate) tube 1. The securable housing component 3 will have a back and two sides with an open front, whereas here there will be two elastic bands 2, made of a rubber-like material that wrap around the securable housing component 3 to serve as a frontal securing method in preventing the power strip from falling out or forwards during usage. The height of the vertical length of the securable housing component is 8 inches in height for proper holding of the vast majority of various power outlet strips.

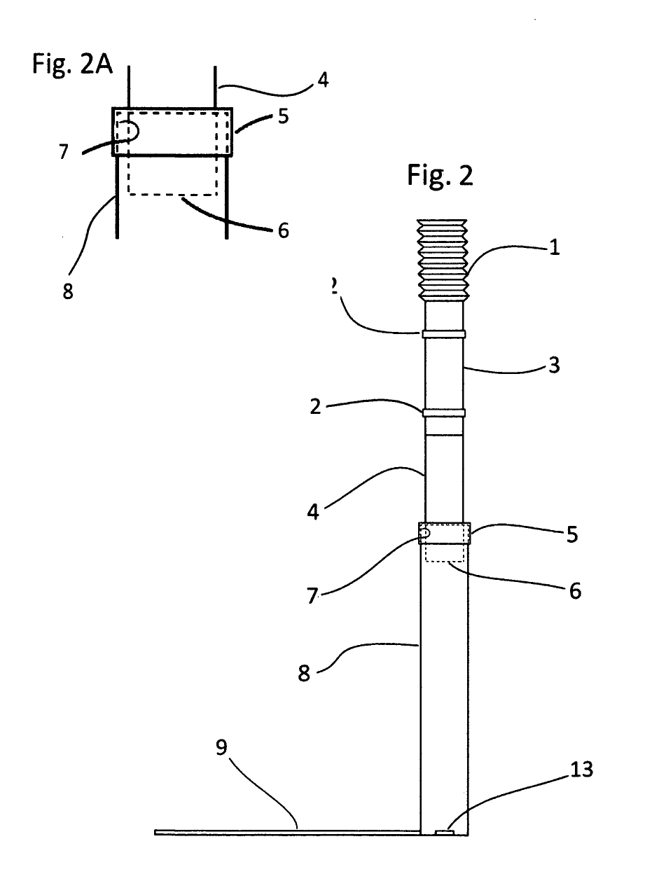

All of the reference numbers within FIG. 1 are again of a front view of the device. In FIG. 2a, the references to parts 4, 5, 6, 7, and 8 of both FIG. 1 and FIG. 2 accordingly are presented as a blown up image of the parts to provide clear understanding of this portion of the invention. The reference numbers throughout all FIGS. 1-10 are compatible meaning that where any of the reference numbers in FIG. 1 are described; each of these references resemble the same component of elements as previously described. However, there will be new reference numbers throughout the presented FIGS. 1-10, but mainly each different Figure is representing simply a different view of the invention and not a different element or component. Therefore, simply by taking notice of each identical reference number between FIGS. 1 through 10 should provide the understanding that each Figure is of the same elements (possibly a few added elements), but that each drawing as depicted is simply another independent view of the invention to provide a vast, yet feasible understanding of the invention.

In FIG. 2, the image provided is a side view of the device, and showing an extended yet contorted version of the invention. While the similar reference numbers resemble the same element, reference 2 for example in FIG. 2 represents a back view of the elastic (rubber-like), bands which are described in FIG. 1 under reference 2. The elastic bands 2 in FIG. 2 resemble the back view of the bands because the accordion (plicate), tube 1 is bent in a manner that when looking directly at the invention from the side view provided, the back of the securable housing 3 will be seen when bent because of its attached position on the top of the accordion (plicate), tube 3. The same concept applies to the understating of FIG. 2 according to the legs 9 and 13, in which are shown as they are because they are now being seen from a side view instead of a front view as in FIG. 1. FIG. 2A, for clarity, is shown to describe the reference elements based on FIG. 2, and of course each image which favors the same given reference numbers hereon.

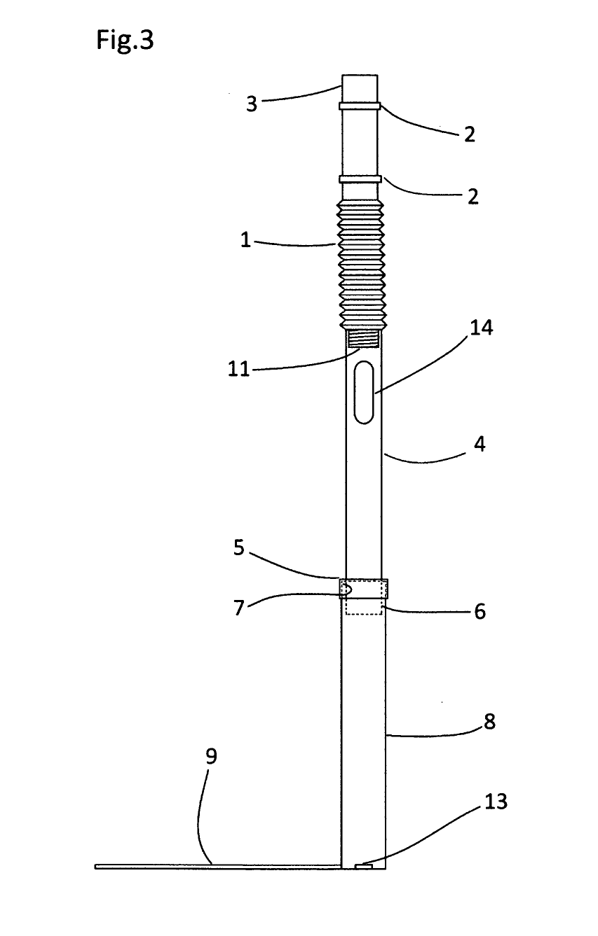

In FIG. 3, the drawing represents another side view of the invention in its fully extended non-bent view. Each of the reference numbers resemble the same and correct elements of the previous FIG. 2 being that FIG. 2 was also a side view. However, there is a new reference number introduced in FIG. 3 which is a side of the same power outlet strip cord opening as mentioned in FIG. 1 under reference number 12. Likewise, the reference number 14 in FIG. 3 is representing a clear side view of the cord-opening through which the cord will pass upon use of the device presented. The accordion (plicate), tube 1 is a side view of the component in which the tube is hollow for further detail; so that the cord of the power outlet strip may be inserted from the top of the accordion (plicate), tube and down the tube until the cord reaches the cord-opening 14 and exits out of the device so that it can plug into the users wall outlet. At this point the power outlet strip would rest in the securable housing 3 with all of the cord of the power outlet strip being pulled through the device where intended and described as to allow the power strip to fit properly within the securable housing component 3. Furthermore, the elastic bands 2 are then adjusted to a useful position to hold the power strip securely from falling out or forwards.

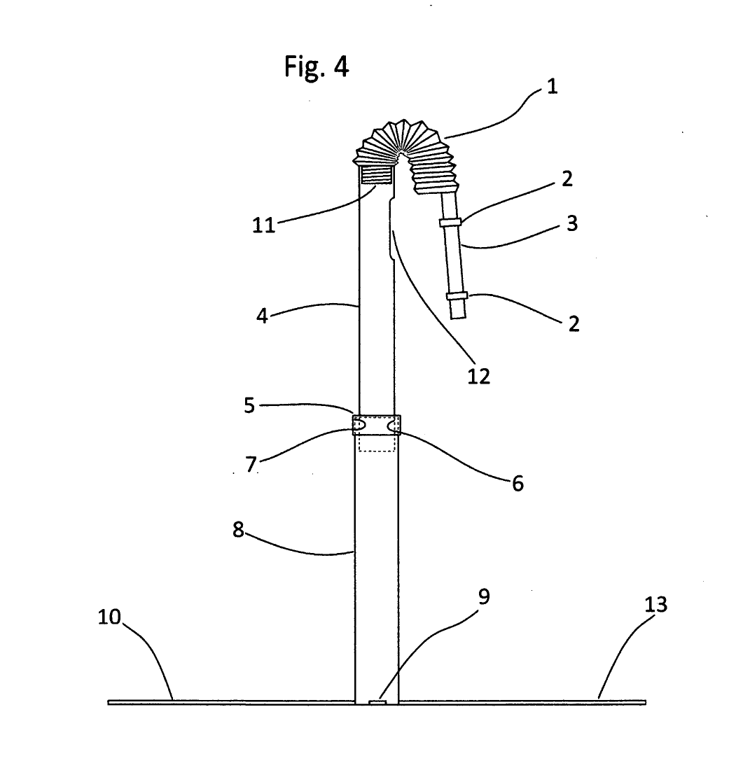

FIG. 4 resembles the invention similar to FIG. 1, in that the image is a front view when facing the structure. However, in this image the invention is demonstrating its bent capability in the version of a side view to possibly better understand the device in its entirety. Furthermore, reference numbers 1, 2, and 3 which are the same described elements as before, are shown as bent or contorted in FIG. 4. In reference to the legs 10, 9, and 13 of FIG. 4, these legs 10, 9, and 13 are in the same viewing position as the side view shown in FIG. 1. In another reference to FIG. 4 as shown, the device of FIG. 4 in a fully extended, yet bent position, which would reach the height of about 36 inches tall. Reference numbers 4, 5, 6, 7, 8, 11, and 12 as shown in FIG. 4 are each related to the precise components of FIG. 1; as these reference numbers resemble the side view elements of equal meaning in both Figures presented.

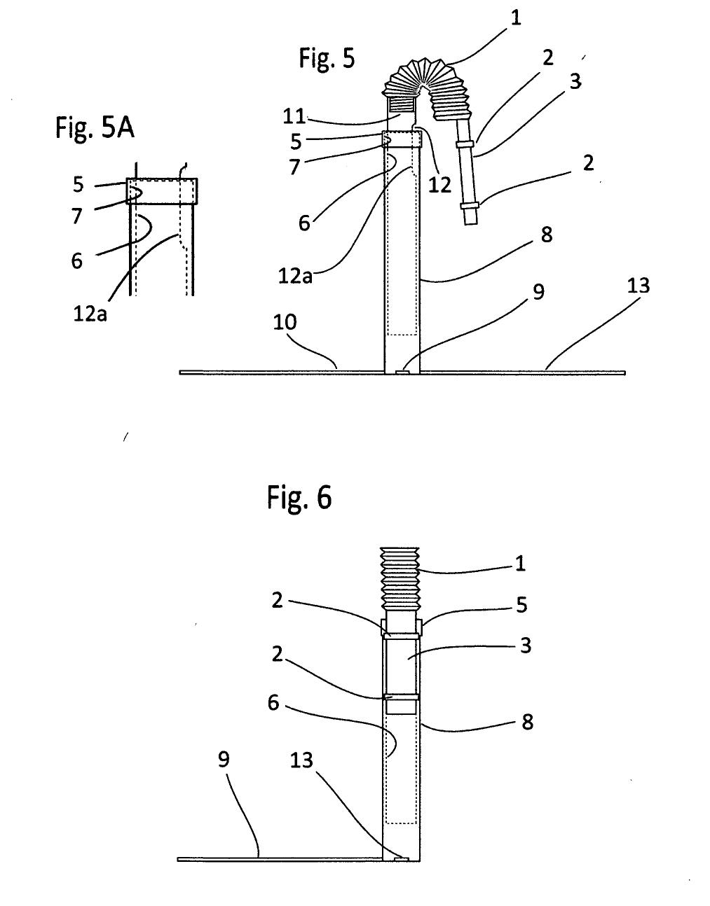

In FIG. 5 of the drawings the invention is a fully shortened and a bent version of the invention shown in a front view depiction. The drawing of the invention in FIG. 5 contains the lowercase letter “a”, which is accommodating the reference number 12 in this image to better identify what is being presented. Each of the similar reference numbers as shown is the previous Figure drawings are again the same elements or components. However, reference number 12A in this drawing is representing the portion of the original cord opening 12, in which the dashed line of the cord opening 12A shown is resembling the portion of the cord opening 12 upon mobile pole 4, which has been inserted inside of the base pole to the device's shortest height. The cord opening 12 shown will still indeed provide the required amount of space needed for the power outlet cord to pass through successfully. The height of the entire device its adjusted form of FIG. 5 is about 2 feet tall. This lowest level of height can be used by the user in the event they may wish to use the device near a table or another object of similar height where the invention is found useful. FIG. 5a demonstrates the same references as listed in FIG. 5 as a blown up image for precise comprehension of the device.

On the same page as FIGS. 5 and 5A, FIG. 6 is presented as a fully shortened side view of the device in which the accordion (plicate), tube 1 is bent to further justify the invention's various capabilities from a different viewing angle as provided. Reference numbers 2 and 3 in this image are again referring to the back side of the securable housing component 3 and the elastic bands 2. The only difference in FIG. 6, compared to FIG. 2, is the height difference of the overall device, in which FIG. 6 is simply a shortened version of FIG. 2. Every reference number provided within both images are the same in terms of what specific element or component the references are referring to.

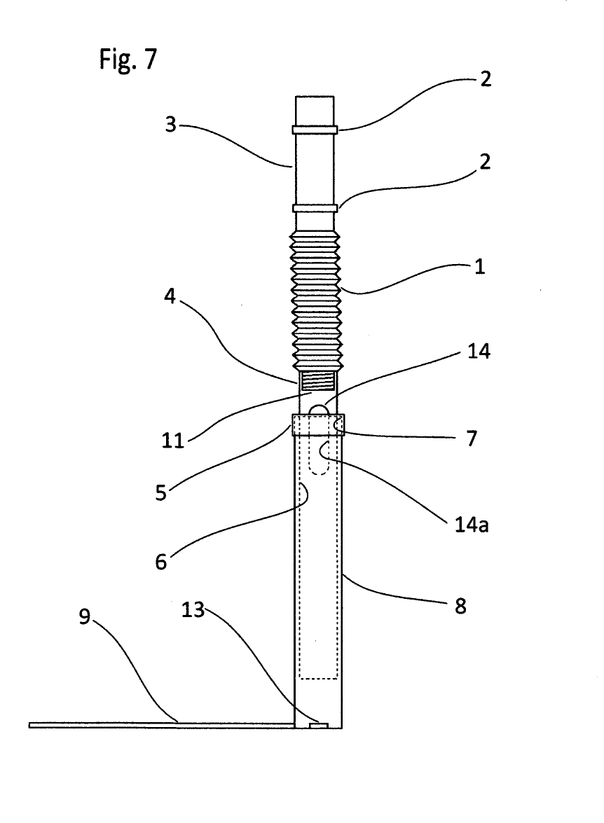

Furthermore, FIG. 7 as shown is depicting the device fully shortened but not bent. The image of FIG. 7 is comparable to the image of FIG. 3, in which each is a side view but not bent. However, being that FIG. 7 is a shortened version of a side view of the device, there is one new reference number which is 14A. Reference number 14A resembles the portion of the cord opening 14 inside of the base pole 8 as shown. Reference number 6 in FIG. 7 is showing the rest of the mobile pole 4, which is also inside of the base pole 8. This adjustment again will lessen the height of the device. All other reference numbers used in FIG. 7 are in accurate correspondence with the previously used and described reference numbers of the other side view Figures, and to what component or element they refer to.

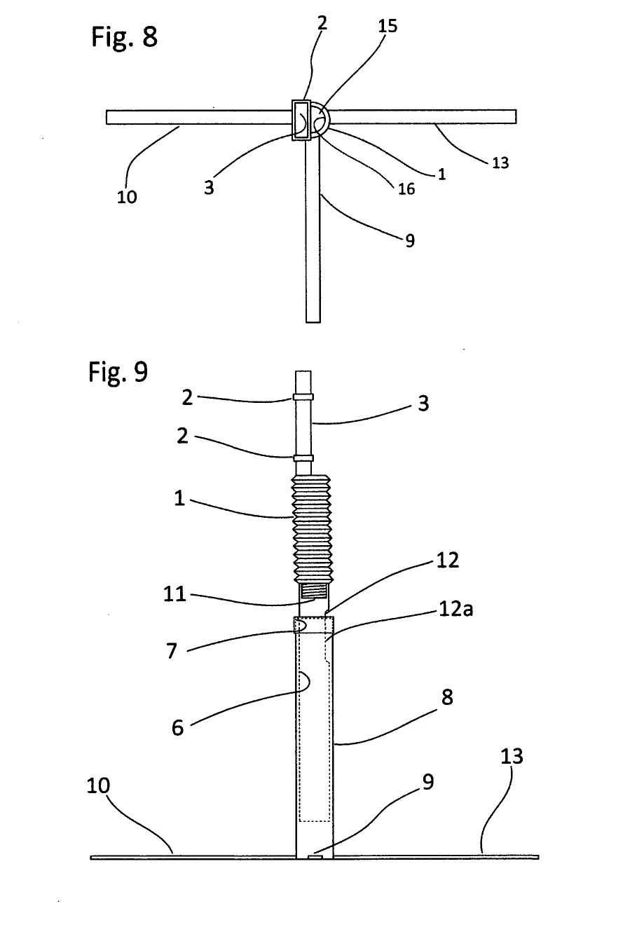

In FIG. 8, a top view is provided for extended understanding of the device. The FIG. 8 top view shows the legs 10, 9 and 13 as previously described. The elastic band(s) 2 is shown as it will travel the perimeter of the securable housing component 3. The elastic band(s) is showing space between it and the securable housing component 3 for the sake of confusion. The actual elastic band(s) however, will fit snug against the perimeter of the securable housing component 3 when the invention is in use. Reference number 1 in FIG. 8 is demonstrating the outside of the accordion (plicate), tube 1. Reference number 16 of FIG. 8 represents the inside edge of the securable accordion (plicate) tube 1 to emphasize that this component has a certain thickness based on the accordion (plicate) tube 1 design which allows this component 1 to collapse and bend to different angles while maintaining the direction pointed towards until altered again. The ability of the accordion (plicate) tube 1 to collapse and fold is based on the intended foldable bends of the tube component 1 allowing this capability. Reference number 15 in FIG. 8 represents the hollow, open space within the tube component 1 in which the power cord of the power outlet strip will initially enter and then exit the previously described cord opening 12 in FIG. 1, for example.

FIG. 9 is shows another front view of the invention in which the device is fully shortened in its front view, but not bent. The reference numbers within FIG. 9 are entirely compatible with the reference numbers of FIG. 5. The only difference in FIG. 9 from FIG. 5 is that FIG. 5 is bent in its fully shortened side view image. The components and reference numbers which are the same as listed in each drawing will also represent the same component or element in terms of what the component or element resembles. The bent image versus the non-bent image allows understanding of the only real difference between FIG. 9 and FIG. 5.

The final Figure, FIG. 10, demonstrates the invention in an exploded frontal view of the device. Each of the reference numbers again represents the previously explained descriptions of each corresponding reference number provided. FIG. 10 is showing the device in its individual yet whole component or elements. If the components or elements were to fall together or come together as recognized, then the image would feasibly form the invention as a whole image as the device has been described. The invention can be placed in a user's home, workshop, business office or wherever the device is found useful, and used based on the details provided. In conclusion, the present invention of the free-standing power strip accessory is disclosed as previously described.

1) I Claim, an apparatus for retaining an electrical device at multi-adjustable extents comprising of:
a) a fundament which provides required balance of said apparatus;
b) a vertical component consisting of: pole(s), tube(s), rod(s), or necessary bracing for the increase and decrease of elevation for a portion of the multi-adjustable capabilities of said apparatus;
c) a serviceable plicate component which may be made up of a material such as a durable plastic, metal, or material of equal status in terms of usage;
d) a securable housing for the said retaining portion of a said electrical device.

2) The fundament of claim 1, in which the fundament seemingly favors the capital letter “T” whereas each branch of the “T” appearance resembles an individual support for said balance required of the said apparatus.

3) The said retaining portion of said apparatus of claim 1, in which this portion joins with said serviceable plicate material by the possible means of: glue adhesive, screws, or bolts and nuts.

4) The said serviceable plicate component of claim 1, further obtaining the ability to be adjusted to various angles of preference in reference to the said multi-adjustable extents portion of the said apparatus.

5) The serviceable plicate component of claim 4, which can maintain its preferred position until an individual alters the position to a various preference.

6) The securable housing of an electrical device in claim 1, which contorts accordingly with the adjustable abilities of the said serviceable plicate component.

7) The securable housing of an electrical device of claim 6, furthermore comprising of: bands or a frontal casing which provides as a form of securing the said electrical device in reference to the said securable housing

8) The serviceable plicate component of claim 4, in which one of the two ends of the said component is able to attach to the upper portion of the said vertical component of said vertical pole(s), rod(s), tube(s), or necessary bracing by the possible method of the said serviceable plicate component screwing into an upper threaded portion of the other component of the said pole, rod, tube, or necessary bracing, or by the means of clamp(s) or possibly glue.

9) The upper portion consisting of said pole(s), rod(s), tube(s), or necessary bracing component of claim 8, which may furthermore have a opening in this upper portion of the said vertical pole(s), rod(s), tube(s), or bracing component for which an electrical devices' cord can pass through.

10) The said pole(s), rod(s), tube(s), or necessary bracing component of claim 9, in which one pole, rod, tube, or bracing can be a changeable pole, rod, tube, or bracing within another pole, rod, tube, or bracing in which provides said adjustability in height of the said apparatus.

11) An electrical device as in claim 1, which such a device may be a power outlet strip of a sort.

12) The apparatus in claim 1, whereas the device in its entirety is not a conductor of electricity in itself; safe for use of retaining a said electrical device.

13) The said pole(s), rod(s), tube(s), or necessary bracing component of claim 10, furthermore are united by the means of a coupler which may be a ring, inner lining, clamp, or connector comprising of silicone, rubber, plastic or metal.

14) The apparatus of claim 1, remains at a preferred said extent of height in which one said pole, rod, tube, or necessary bracing may be stable whilst another said pole, rod, tube, or necessary bracing can be changeable or set at a content level of height in which the said coupler may assist in allowing such capability by providing a snug fit.

15) An apparatus for holding a power outlet strip at adjustable extents in which the said device can be used in various areas of a home, workshop, or business office where its functions are appropriate and deemed as useful.
